(19) United States
(12) Patent Application Publication
(10) Pub. No.: US 2010/0208739 A1
(43) Pub. Date: Aug. 19, 2010

(54) METHOD FOR SELECTING RELAY IN WIRELESS BROADCAST AD HOC NETWORKS

(75) Inventor: Orit Ofri, Timrat (IL)

Correspondence Address: YORAM TSIVION, P.O. BOX 1307, PARDES HANNA, 37111, IL

(73) Assignee: RAFAEL-ARMAMENT DEVELOPMENT, Haifa (IL)

(21) Appl. No.: 12/304,774

(22) PCT Filed: Jun. 13, 2007
(86) PCT No.: PCT/IB2007/052244

§ 371 Date: Dec. 15, 2008

(30) Foreign Application Priority Data
Jun. 15, 2006 (IL) 176331

(51) Int. Cl. H04L 12/28

(52) U.S. Cl. 370/400

(57) ABSTRACT

The method of the invention is implemented in ad hoc communications network employing at least two-hop routing and wherein each node in the network employs an omnidirectional send/receive capability. Each node keeps a near neighbour database (NND) updated by receiving of messages. Each Othernode in the network, the message of which was received by Mynode in a time period T, is a candidate for becoming a relay for transmitting Mynode's messages. The probability of an Othernode to become a relay for Mynode is higher for a larger amount of candidates Othernode has in its NND. The probability for the Othernode to become a relay is higher the larger its distance from Mynode.

### FIELD OF THE INVENTION

The present invention is in the field of ad hoc communications networks. More specifically the invention relates to bandwidth restricted wireless multi hop networks.

### BACKGROUND OF THE INVENTION

An ad hoc wireless communications network is a wireless network having no central organizing node or pre-defined infrastructure. Usually, all participating nodes are to make decisions and all nodes within the range of a transmitting node receive packets from the transmitting node. Typically, the invention is implemented in ad hoc wireless networks in which each node is unaware of the total network topology, rather it utilizes the local topology for each node. Such a network was presented by L. Bao and J. J. Garcia-Luna-Aceves, “Distributed Dynamic Channel Access Scheduling for ad hoc Networks”, Journal of Parallel and Distributed Computing, Volume 63, pp. 3-14, January 2003, the contents of which are incorporated herein by reference. In a wireless communications channel of the invention, the distribution mode of time slots S₁ . . . Sₙ is known to the various nodes. The slots are available to Mynode in compliance with rules of the networks. A set of nodes (end-points), optionally mobile in space, are listed in Mynode's node database. Each such node is potentially capable of sending a message, at any slot along the time axis, and incurring a collision with Mynode's message if it is sent at the same time. In the network discussed hereinbefore, other nodes are possibly participating, which are not addressable by Mynode. The number of listed Othernodes stored in Mynode's node database may be dynamic, but every node possesses a unique unchangeable network ID.

A node database in Mynode contains the list of the IDs of nodes which are likely to inter-collide in slots of the channel. For example, in U.S. Pat. No. 5,396,644, the contents of which are incorporated herein by reference, a node stores data of its near neighbours, and whenever it sends a neighbour update signal, it sends a list of near neighbours and their IDs. This way, each node is always kept updated as to the list of neighbours and the neighbours of each neighbour.

### BRIEF DESCRIPTION OF THE DRAWINGS

FIG. 1A is a schematic description of a topological aspect of network in which the invention is implemented, Mynode communicates with three neighbouring Othernodes of the network.

FIG. 1B is a schematic presentation of Mynodes' neighbours having changed their position in space.

FIG. 2 is a flow chart describing the refreshing procedure of the list of candidates in Mynode's near neighbour database.

### DETAILED DESCRIPTION OF THE PRESENT INVENTION

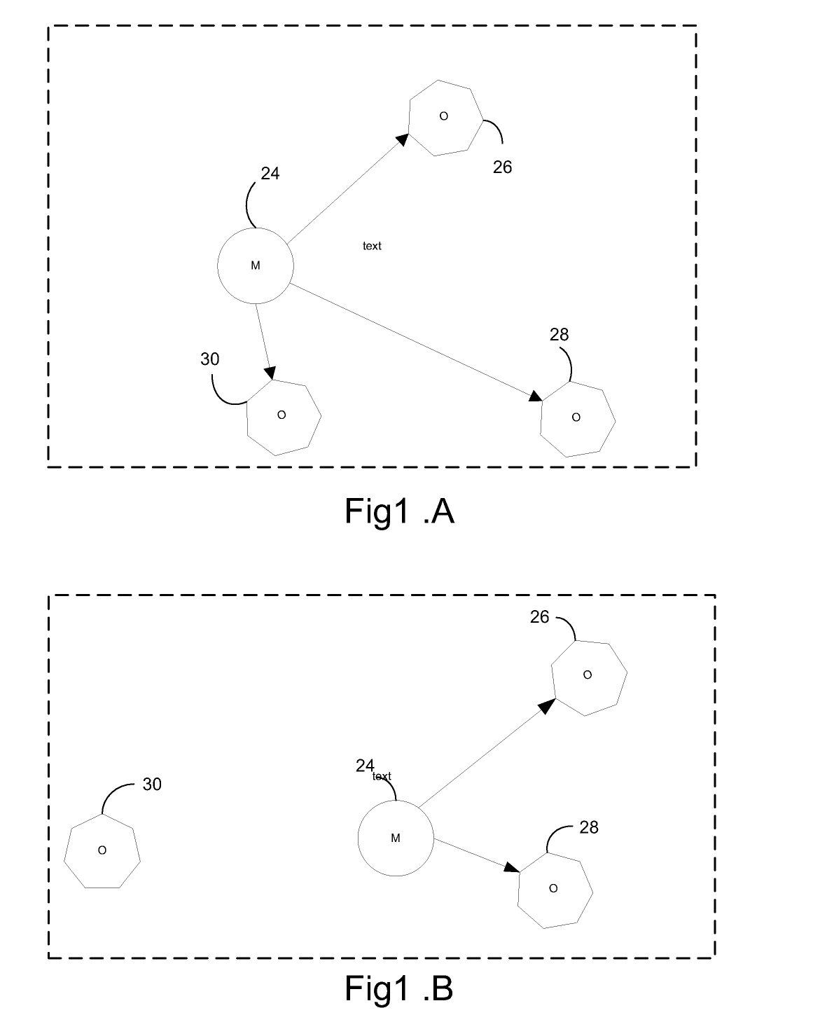

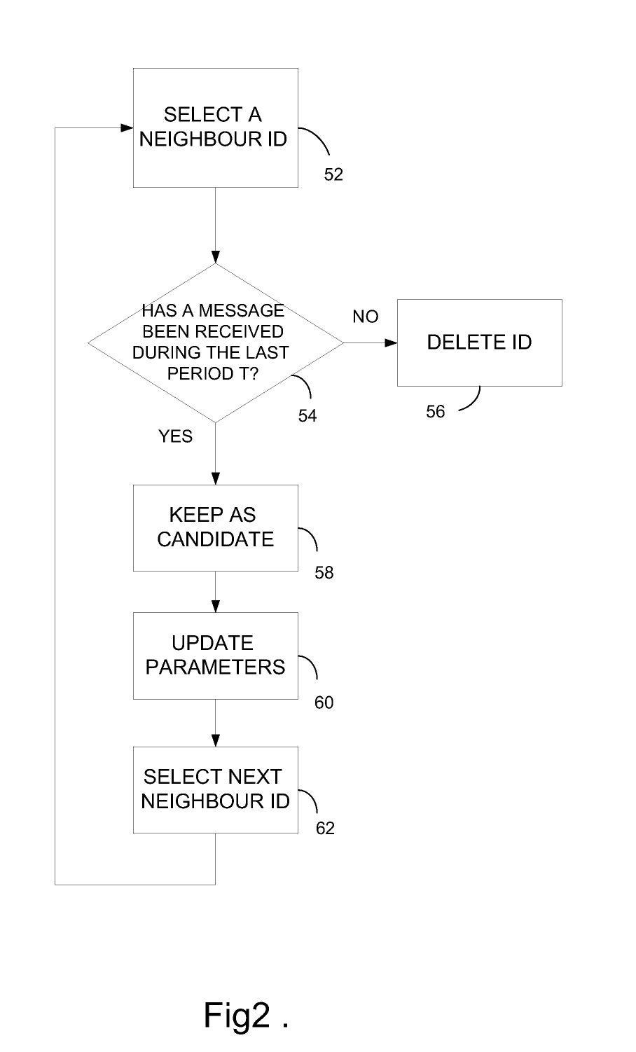

The method of the invention is implemented in ad hoc communications systems employing at least two-hop routing. The method of the invention is intended for minimizing the control traffic of the network and is therefore suitable for such networks having a limited available bandwidth. Mynode and all Othernodes are typically dynamically positioned in space capable of transmitting and receiving in all directions. In FIGS. 1A and 1B, some topological aspects of the network in which the invention is implemented are described. In FIG. 1A, Mynode 24 is positioned at a certain point in time relative to Othernodes 26, 28 and 30 and can send messages to each of them. Later, as described in FIG. 1B, Mynode 24 can transmit packets to Othernodes 26 and 28 but cannot transmit a packet to Othernode 30, possibly because of the increased distance now separating the two nodes. The nodes in a system implementing the invention, use a particular method for choosing a relay node as will be explained next.

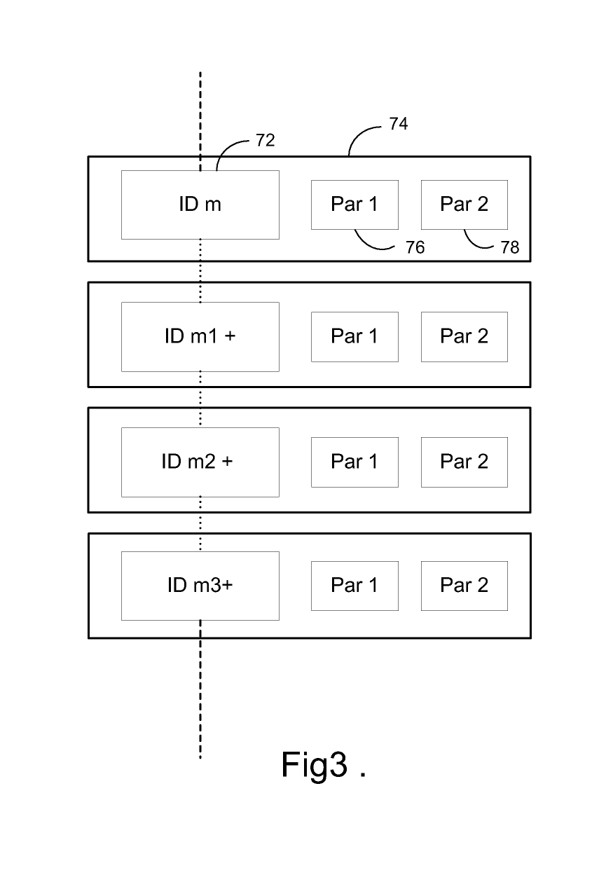

Each node in the network employs a neigbouring node database (NND) which includes a list of near neighbour ID (a unique identity designator), and two parameters associated with each such node, i.e., the distance to the neighbour and the number of neighbours it has. Thus, for example, Mynode has a database momentarily including 23 nodes each having the two parameters. Any stored ID is to be deleted automatically if for a predetermined period of time it will not send an update signal. Mynode, receives update signals periodically, from each Othernode sending such signal and in a physical position as to be received by Mynode. The maintenance chart for maintaining the NND is shown in FIG. 2 to which reference is now made. Neighbour ID is selected in step 52. The maintenance system then checks in step 54 if a maintenance message has been received during the period of time T. If such a message has not been received the ID is then to be deleted from the database in step 56. If a maintenance message was received at that period of time, the ID is to be regarded as a candidate for relaying purposes in step 58, and its associated parameters are updated in step 60. In step 62 the next neighbour ID is selected to start the procedure again for that next ID. To save on bandwidth, the maintenance message referred to above and sent by Othernode contains an updated number of listed neighbours of the sending Othernode as listed in Othernode's database. To complete updating of the parameters in step 60 above, the distance between the sending Othernode and Mynode is measured and transferred to the database. Any node, having a unique ID not as yet listed in Mynode's NND, whose maintenance message is received by Mynode, will be added in to the NND. The NND of Mynode contains components as described in FIG. 3 to which reference is now made. IDm is database number 72 of a node in the network having a unique ID, and having sent a maintenance message that has maintained its validity in Mynode's database. Record 74 contains therefore, in addition to IDm, the associated two parameters. One parameter is the number of neighbours that IDm has in its database, and the second parameter is the distance measured to the respective node. Parameter 76 is obtained from the last maintenance message sent by the respective node. Parameter 78 relates to the distance between Mynode and the node having IDm as a database number in Mynode's NND. The maintenance messages described above are useful for carrying NND update information but other message types can also be used for the same purpose.

Selecting a Relay Node

It is the main concern of the system in which the invention is implemented to keep the amount of control signals to a minimum in order to allocate the limited available bandwidth to speech/data traffic. In accordance with the relay selection algorithm (RSA) of the invention, a relay is selected out of the NND. Two selection rules are implemented in the choosing of the relay, one relates to the distance of the node from Mynode, and the other relates to the number of neighbours each Othernode has in its respective NND.

To summarize the rules for selecting a relay, firstly, Othernode m has a higher probability of becoming Mynode's relay than Othernode k at the same distance from Mynode, if it has more candidates in its NND than Othernode k. Secondly, Othernode m has a higher probability of becoming Mynode's relay than Othernode k, if its distance from Mynode is larger than the distance of Othernode k while having the same number of candidates in its NND as Othernode k. These two rules apply providing that Mynode's candidate is listed in its NND. The farther a candidate is positioned from Mynode, the less the number of common nodes it has with Mynode. Secondly, the more neighbours a candidate has, the higher the chances of it becoming a relay for Mynode.

Declaration Regarding a Relay

The Othernode to be selected by Mynode becomes effectively a relay once it has received a message declaring the choice. The message is sent by Mynode and received by all connectable Othernodes, but only an Othernode having the matching ID as sent in the declaration message will automatically become a relay.

1. An ad hoc communications network employing multi-hop routing, wherein each node employs an omnidirectional send/receive capability and keeps a near neighbour database (NND) updated by receiving of messages, wherein each Othernode the message of which was received by Mynode in a time period T, is a candidate for becoming a relay for transmitting Mynode's messages, and wherein the probability of an Othernode to become a relay for Mynode is higher for a larger amount of candidates said Othernode has in its NND, and the probability for said Othernode to become a relay is higher the larger its distance from Mynode.

2. An ad hoc communications network as in claim 1, wherein said NND is updated using at least maintenance messages sent periodically by each node.

3. An ad hoc communications network as in claim 1 wherein the bandwidth available is limited.
